(19) United States
(12) Patent Application Publication
(10) Pub. No.: US 2022/0143813 A1
(43) Pub. Date: May 12, 2022

(54) INDUSTRIAL ROBOT

(71) Applicant: NIDEC SANKYO CORPORATION, Nagano (JP)

(72) Inventor: Tamotsu KURIBAYASHI, Nagano (JP)

(73) Assignee: NIDEC SANKYO CORPORATION, Nagano (JP)

(21) Appl. No.: 17/520,720

(22) Filed: Nov. 8, 2021

(30) Foreign Application Priority Data
Nov. 9, 2020 (JP) 2020-186268

(51) Int. Cl. B25J 9/04; B25J 9/06

(52) U.S. Cl. CPC B25J 9/042; B25J 9/06

(57) ABSTRACT

An industrial robot includes a supported part, a support part which is disposed on a lower side with respect to the supported part and with which the supported part is turnably connected, a turning member to which the supported part is fixed from an upper side so as to be turned together with the supported part and which is turnably held by the support part, a fixing bolt for fixing the supported part to the turning member, and a lifting bolt for lifting the supported part with respect to the turning member.

### CROSS REFERENCE TO RELATED APPLICATION

The present invention claims priority under 35 U.S.C. § 119 to Japanese Application No. 2020-186268 filed Nov. 9, 2020, and the entire content of which is incorporated herein by reference.

### FIELD OF THE INVENTION

At least an embodiment of the present invention relates to, for example, an industrial robot for conveying a conveyance object.

### BACKGROUND

Conventionally, a horizontal multi-joint type industrial robot has been known (for example, see Japanese Patent Laid-Open No. 2020-69575 (Patent Literature 1)). An industrial robot described in Patent Literature 1 includes a hand on which a substrate (glass substrate) is mounted, an arm which is turnably connected with the hand on its tip end side, and a main body part which is turnably connected with a base end side of the arm. The arm is structured of a first arm part whose base end side is turnably connected with the main body part and a second arm part whose base end side is turnably connected with a tip end side of the first arm part. The hand is turnably connected with a tip end side of the second arm part.

In the industrial robot described in Patent Literature 1, the arm is disposed on an upper side of the main body part, and the hand is disposed on an upper side of the arm. Further, a base end part of the second arm part is disposed on an upper side of a tip end part of the first arm part. A speed reducer is disposed in a connecting part of the first arm part with the second arm part. The speed reducer is a hollow wave gear device. A case body of the speed reducer is fixed to the tip end part of the first arm part with bolts. An output shaft of the speed reducer is disposed on a lower side of the base end part of the second arm part. The base end part of the second arm part is fixed to the output shaft of the speed reducer with bolts from an upper side, and the output shaft of the speed reducer is capable of turning together with the second arm part with respect to the first arm part.

In an industrial robot described in Patent Literature 1, when the arm is extended with respect to the main body part after the industrial robot has been assembled, the arm is resiliently bent by an own weight of the hand and the like and thereby, a turning center axis of the hand may be inclined with respect to an upper and lower direction (vertical direction). Therefore, in the industrial robot described above, for example, after the industrial robot has been assembled and before the industrial robot is shipped from a factory, it may occur that a shim is inserted between a lower face of the base end part of the second arm part and an upper end face of an output shaft of the speed reducer to adjust an inclination of a turning center axis of the hand with respect to the upper and lower direction.

In the industrial robot described in Patent Literature 1, when a shim is to be inserted between a lower face of the base end part of the second arm part and an upper end face of the output shaft of the speed reducer, it is required to loosen the bolts for fixing the base end part of the second arm part to the output shaft of the speed reducer and lift the second arm part with respect to the output shaft of the speed reducer. However, the lifting work for the second arm part has been conventionally performed by a worker by utilizing a dedicated jig or by human power. Therefore, in the industrial robot described in Patent Literature 1, the lifting work for the second arm part is very hard work.

### SUMMARY

In view of the problem described above, at least an embodiment of the present invention may advantageously provide an industrial robot which includes a supported part and a support part, which is disposed on a lower side with respect to the supported part and is connected with the supported part, the industrial robot being capable of easily performing lifting work for the supported part.

According to at least an embodiment of the present invention, there may be provided an industrial robot which is a horizontal multi-joint type industrial robot and including: a supported part, a support part which is disposed on a lower side with respect to the supported part and with which the supported part is turnably connected, a turning member to which the supported part is fixed from an upper side so as to be turned together with the supported part and which is turnably held by the support part, a fixing bolt configured for fixing the supported part to the turning member, and a lifting bolt configured for lifting the supported part with respect to the turning member.

An industrial robot in accordance with at least an embodiment of the present invention includes a lifting bolt for lifting a supported part with respect to a turning member. Therefore, in at least an embodiment of the present invention, when the lifting bolt is turned in a state that the fixing bolt for fixing the supported part to the turning member has been loosened, the supported part can be lifted with respect to the turning member which is turnably held by the support part. Accordingly, in at least an embodiment of the present invention, lifting work for the supported part with respect to the turning member can be performed easily. Further, lifting work for the supported part with respect to the turning member can be performed easily and thus, work for inserting a shim between the supported part and the turning member can be performed easily.

In an embodiment of the present invention, for example, the industrial robot further includes: a hand; an arm with which the hand is turnably connected with a tip end side of the arm; and a main body part with which a base end side of the arm is turnably connected. The arm includes an upper side arm part as the supported part and a lower side arm part as the support part, and a base end side of the upper side arm part is turnably connected with a tip end side of the lower side arm part.

In an embodiment of the present invention, for example, the arm includes: a first arm part whose base end side is turnably connected with the main body part; a second arm part whose base end side is turnably connected with a tip end side of the first arm part; and a third arm part whose base end side is turnably connected with a tip end side of the second arm part. In a relationship between the first arm part and the second arm part, the first arm part is the lower side arm part and the second arm part is the upper side arm part and. In a relationship between the second arm part and the third arm part, the second arm part is the lower side arm part and the third arm part is the upper side arm part.

In an embodiment of the present invention, for example, the industrial robot further includes: a hand; an arm with which the hand is turnably connected on a tip end side of the arm; and a main body part as the support part with which a base end side of the arm is turnably connected. And, the arm includes a first arm part as the supported part whose base end side is turnably connected with the main body part.

In an embodiment of the present invention, the supported part is provided with a screw hole with which the lifting bolt is engaged, and a lower end of the lifting bolt is capable of contacting with an upper face of the turning member. According to this structure, when the lifting bolt is turned from an upper side with respect to the supported part, the supported part can be lifted with respect to the turning member. Therefore, in comparison with a case that a screw hole with which the lifting bolt is engaged is provided in the turning member and that an upper end of the lifting bolt is capable of contacting with a lower face of the supported part, lifting work for the supported part can be further easily performed.

Further, according to at least an embodiment of the present invention, there may be provided an industrial robot including: a supported part, a support part which is disposed on a lower side with respect to the supported part and is connected with the supported part so that the supported part is capable of linearly sliding, a slide member to which the supported part is fixed from an upper side and which is capable of sliding together with the supported part and is slidably held by the support part, a fixing bolt configured for fixing the supported part to the slide member, and a lifting bolt configured for lifting the supported part with respect to the slide member.

An industrial robot in at least an embodiment of the present invention includes a lifting bolt for lifting a supported part with respect to a slide member. Therefore, in at least an embodiment of the present invention, when the lifting bolt is turned in a state that the fixing bolt for fixing the supported part to the slide member has been loosened, the supported part can be lifted with respect to the slide member which is slidably held by the support part. Accordingly, in at least an embodiment of the present invention, lifting work for the supported part with respect to the slide member can be performed easily. Further, lifting work for the supported part with respect to the slide member can be performed easily and thus, work for inserting a shim between the supported part and the slide member can be performed easily.

As described above, according to the present invention, in an industrial robot which includes a supported part and a support part disposed on a lower side with respect to the supported part and connected with the supported part, the industrial robot is capable of easily performing lifting work for the supported part.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a perspective view showing an industrial robot in accordance with an embodiment of the present invention.

FIG. 2 is a side view showing the industrial robot in FIG. 1.

FIG. 3 is an explanatory cross-sectional view showing a structure of a joint part shown in FIG. 2.

FIG. 4 is an explanatory view showing arrangement of fixing bolts and lifting bolts which is viewed from the “E-E” direction in FIG. 3.

FIG. 5 is a cross-sectional view showing a state that a third arm part is lifted in the joint part shown in FIG. 3.

FIG. 6 is a side view showing an industrial robot in accordance with another embodiment of the present invention.

FIG. 7 is an explanatory cross-sectional view showing a structure of a connecting part of a supported part with a support part shown in FIG. 6.

### DETAILED DESCRIPTION

An embodiment of the present invention will be described below with reference to the accompanying drawings.

(Entire Structure of Industrial Robot)

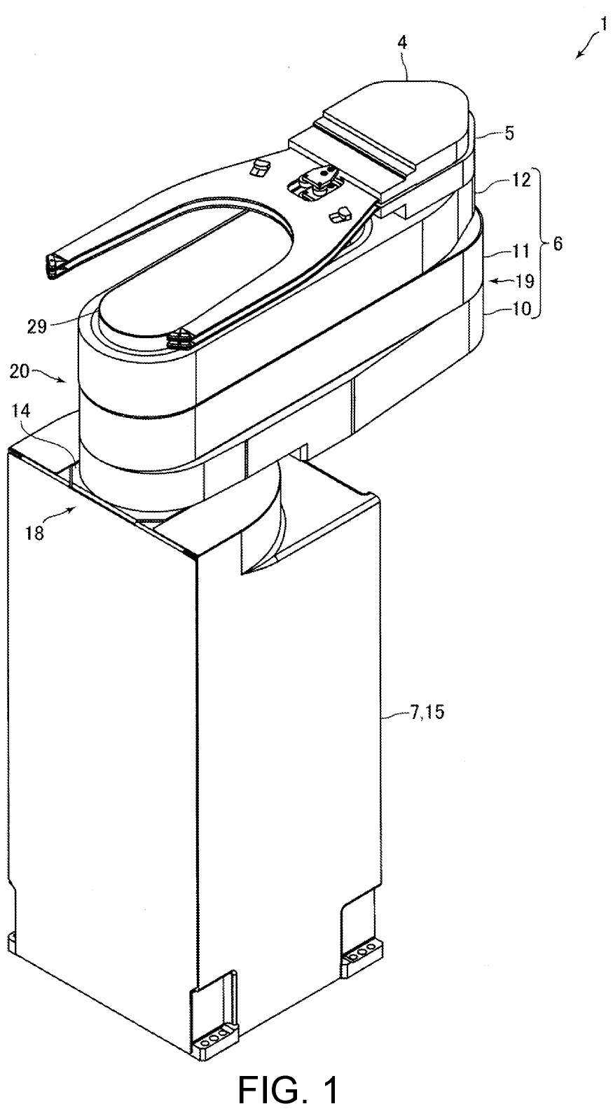

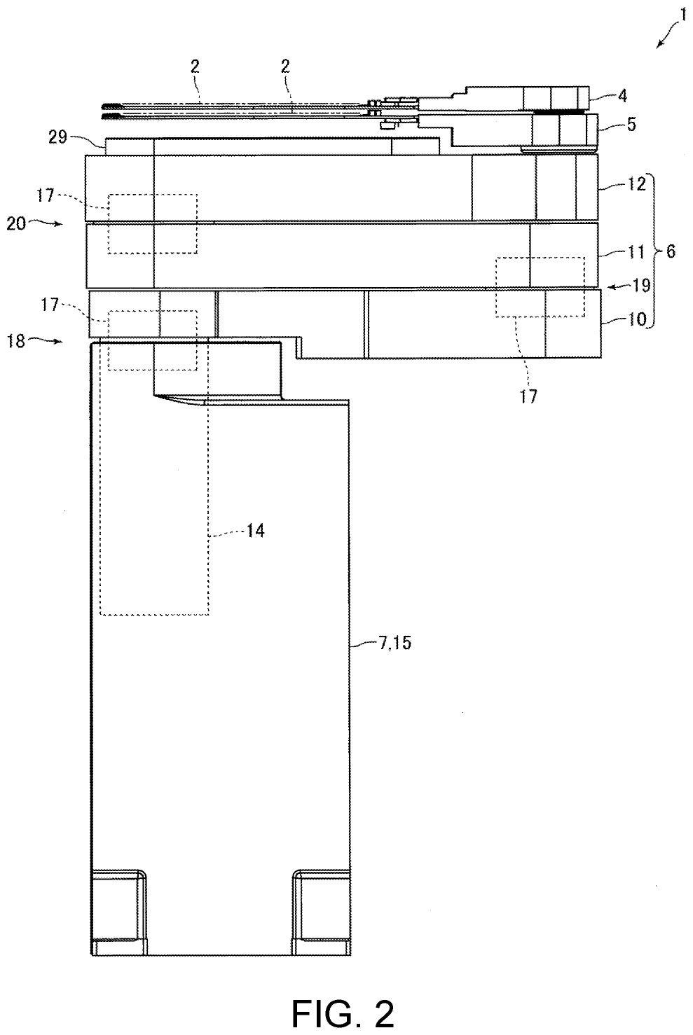

FIG. 1 is a perspective view showing an industrial robot 1 in accordance with an embodiment of the present invention. FIG. 2 is a side view showing the industrial robot 1 in FIG. 1.

The industrial robot 1 in this embodiment is a horizontal multi-joint type robot for conveying a semiconductor wafer 2. The industrial robot 1 is incorporated and used in a semiconductor manufacturing system. The industrial robot 1 includes two hands 4 and 5 on each of which a semiconductor wafer 2 is mounted, an arm 6 with which the hands 4 and 5 are turnably connected on its tip end side and is operated in a horizontal direction, and a main body part 7 with which a base end side of the arm 6 is turnably connected. The semiconductor wafer 2 is formed in a circular plate shape. In the following descriptions, the industrial robot 1 is referred to as a “robot 1” and the semiconductor wafer 2 is referred to as a “wafer 2”.

The arm 6 includes a first arm part 10 whose base end side is turnably connected with the main body part 7, a second arm part 11 whose base end side is turnably connected with a tip end side of the first arm part 10, and a third arm part 12 whose base end side is turnably connected with a tip end side of the second arm part 11. The arm 6 in this embodiment is structured of three arm parts, i.e., the first arm part 10, the second arm part 11 and the third arm part 12. Each of the first arm part 10, the second arm part 11 and the third arm part 12 is formed in a hollow shape.

The main body part 7, the first arm part 10, the second arm part 11 and the third arm part 12 are disposed in this order from a lower side in the upper and lower direction. In other words, the main body part 7 is disposed on a lower side with respect to the first arm part 10, the first arm part 10 is disposed on a lower side with respect to the second arm part 11, and the second arm part 11 is disposed on a lower side with respect to the third arm part 12. In this embodiment, in a relationship between the main body part 7 and the first arm part 10, the first arm part 10 is a supported part, and the main body part 7 is a support part which is disposed on a lower side with respect to the first arm part 10 that is the supported part and with which the first arm part 10 is turnably connected.

Further, in this embodiment, in a relationship between the first arm part 10 and the second arm part 11, the second arm part 11 is a supported part, and the first arm part 10 is a support part which is disposed on a lower side with respect to the second arm part 11 that is the supported part and with which the second arm part 11 is turnably connected. Further, in the relationship between the first arm part 10 and the second arm part 11, the second arm part 11 is an upper side arm part, and the first arm part 10 is a lower side arm part.

In addition, in this embodiment, in a relationship between the second arm part 11 and the third arm part 12, the third arm part 12 is a supported part, and the second arm part 11 is a support part which is disposed on a lower side with respect to the third arm part 12 that is the supported part and with which the third arm part 12 is turnably connected. Further, in the relationship between the second arm part 11 and the third arm part 12, the third arm part 12 is an upper side arm part, and the second arm part 10 is a lower side arm part.

Each of the hands 4 and 5 is formed in a substantially “Y”-shape when viewed in the upper and lower direction. Base end parts of the hands 4 and 5 are turnably connected with a tip end side of the third arm part 12. A turning center of the hand 4 with respect to the third arm part 12 and a turning center of the hand 5 with respect to the third arm part 12 are coincided with each other. Each of the hands 4 and 5 is individually turnable with respect to the third arm part 12. The hands 4 and 5 are disposed on an upper side with respect to the third arm part 12. Further, the hand 4 is disposed on an upper side with respect to the hand 5.

The main body part 7 includes a lifting part 14 with which a base end side of the first arm part 10 is turnably connected, and a housing 15 which holds the lifting part 14 so as to be capable of being lifted and lowered. The base end side of the first arm part 10 is turnably connected with an upper end part of the lifting part 14. An arm elevating mechanism for lifting and lowering the lifting part 14 is accommodated in an inside of the housing 15. The arm elevating mechanism is, for example, structured of a ball screw, a motor for rotating a screw shaft of the ball screw and the like.

Further, the robot 1 includes a hand turning mechanism structured to turn the hand 5 with respect to the third arm part 12, a hand turning mechanism structured to turn the hand 4 with respect to the third arm part 12, an arm part drive mechanism structured to turn the first arm part 10 and the second arm part 11 to extend and contract a part of the arm 6 comprised of the first arm part 10 and the second arm part 11, and a third arm part turning mechanism structured to turn the third arm part 12 with respect to the second arm part 11. The hand turning mechanism includes a motor and a speed reducer which decelerates power of the motor and transmits it to the hand 4 or the hand 5.

The arm part drive mechanism includes a motor and two speed reducers 17 for decelerating and transmitting power of the motor. The motor is disposed in an inside of the housing 15 and is held by the lifting part 14. One of the two speed reducers 17 is disposed in a joint part 18 which connects the lifting part 14 with the first arm part 10 so that power of the motor is decelerated and transmitted to the first arm part 10. The other of the speed reducers 17 is disposed in a joint part 19 which connects the first arm part 10 with the second arm part 11 and power of the motor is decelerated and transmitted to the second arm part 11.

The third arm part drive mechanism includes a motor and a speed reducer 17 for decelerating and transmitting power of the motor. The motor is disposed in an inside of the second arm part 11. The speed reducer 17 is disposed in a joint part 20 which connects the second arm part 11 with the third arm part 12 and is structured to decelerate power of the motor and transmit it to the third arm part 12.

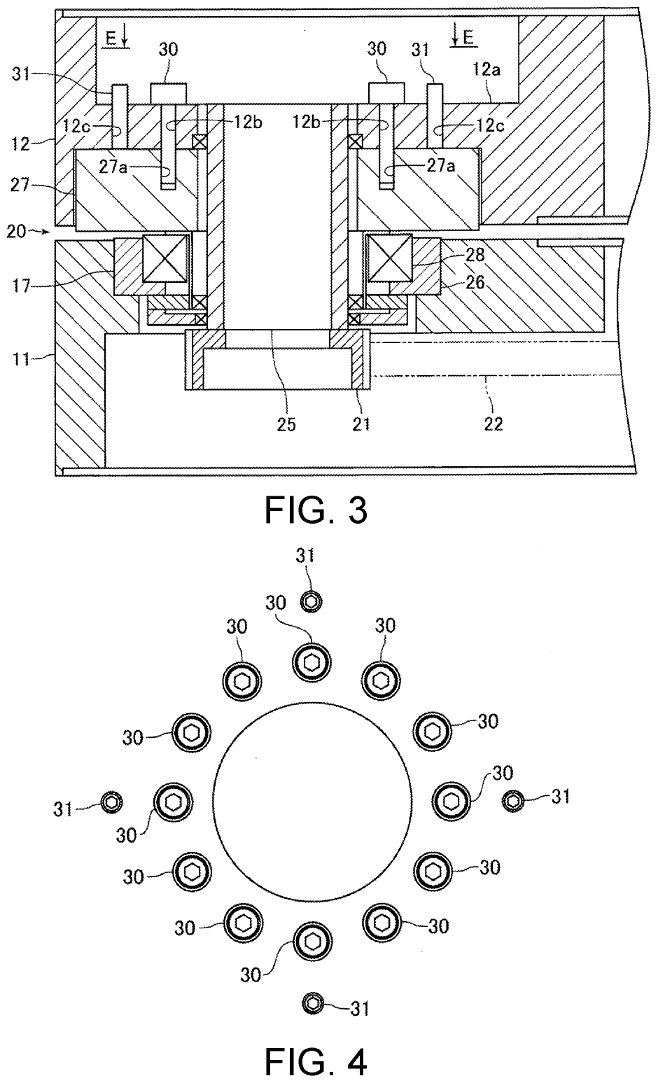

The speed reducer 17 is a hollow wave gear device (harmonic drive (registered trademark)). In the arm part drive mechanism, the motor and the speed reducer 17 are connected with each other through a pulley and a belt similarly to, for example, an industrial robot described in Japanese Patent Laid-Open No. 2011-230256. Further, in the third arm part drive mechanism, the motor and the speed reducer 17 are connected with each other through a pulley 21 and a belt 22 (see FIG. 3) similarly to, for example, the industrial robot described in Japanese Patent Laid-Open No. 2011-230256. In accordance with an embodiment of the present invention, in the third arm part drive mechanism, the motor and the speed reducer 17 may be connected with each other through a bevel gear. Further, the speed reducer 17 may be a speed reducer other than a hollow wave gear device.

(Structure of Joint Part)

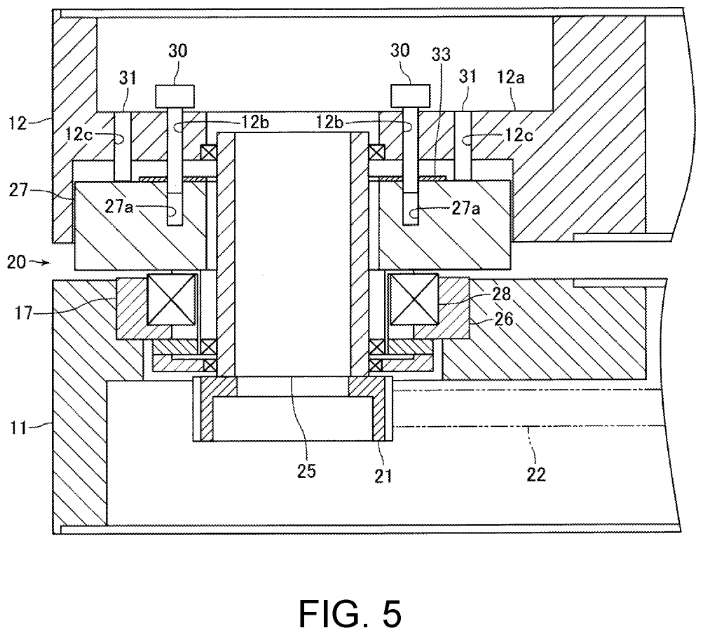

FIG. 3 is an explanatory cross-sectional view showing a structure of the joint part 20 shown in FIG. 2. FIG. 4 is an explanatory view showing arrangement of fixing bolts 30 and lifting bolts 31 which is viewed from the “E-E” direction in FIG. 3. FIG. 5 is a cross-sectional view showing a state that the third arm part 12 is lifted in the joint part 20 shown in FIG. 3.

As described above, the speed reducer 17 is disposed in the joint part 20. Further, as described above, the speed reducer 17 is a hollow wave gear device. A pulley 21 is fixed to a lower end of an input shaft 25 of the speed reducer 17. A case body 26 of the speed reducer 17 is fixed to an upper face part on the tip end side of the second arm part 11. The third arm part 12 is fixed to an output shaft 27 of the speed reducer 17. Specifically, a base end part of the third arm part 12 is fixed to the output shaft 27 from an upper side.

The output shaft 27 is turnably held by the case body 26 through a bearing 28. In other words, the output shaft 27 is turnably held by an upper face part on the tip end side of the second arm part 11 through the bearing 28 and the case body 26. In the joint part 20, the output shaft 27 is a turning member to which the third arm part 12 that is a supported part is fixed from an upper side and which is turned together with the third arm part 12 in a relationship between the second arm part 11 and the third arm part 12. Further, the output shaft 27 that is a turning member is turnably held by the second arm part 11 that is a support part in a relationship between the second arm part 11 and the third arm part 12. An upper face of the output shaft 27 is a flat face perpendicular to the upper and lower direction.

The base end part of the third arm part 12 is formed with a fixed part 12a which is fixed to the output shaft 27. A lower side of the fixed part 12a is formed with a recessed part in which the output shaft 27 is disposed, and the recessed part is recessed from a lower face of the third arm part 12 toward an upper side. Further, an upper side of the fixed part 12a is also formed with a recessed part, and the recessed part is recessed from an upper face of the third arm part 12 toward a lower side. The recessed part is covered by a cover 29 from an upper side (see FIGS. 1 and 2). An upper face and a lower face of the fixed part 12a are flat faces perpendicular to the upper and lower direction. A lower face of the fixed part 12a which is fixed to the output shaft 27 is contacted with an upper face of the output shaft 27.

The joint part 20 is arranged with a plurality of fixing bolts 30 for fixing the third arm part 12 to the output shaft 27 and a plurality of lifting bolts 31 for lifting the third arm part 12 with respect to the output shaft 27. In other words, the robot 1 includes the fixing bolts 30 for fixing the third arm part 12 to the output shaft 27 and the lifting bolts 31 for lifting the third arm part 12 with respect to the output shaft 27. The joint part 20 is, for example, arranged with twelve fixing bolts 30 and four lifting bolts 31.

The fixing bolt 30 is a bolt with a hexagonal hole. The fixing bolt 30 is disposed so that an axial direction of a shaft part of the fixing bolt 30 and the upper and lower direction are coincided with each other. The fixed part 12a (in other words, the base end part of the third arm part 12) is formed with a passing hole 12b through which a shaft part of the fixing bolt 30 is passed. The passing hole 12b is penetrated through the fixed part 12a in the upper and lower direction. The output shaft 27 is formed with a screw hole 27a with which the fixing bolt 30 is engaged (specifically, with which a male screw formed in a shaft part of the fixing bolt 30 is engaged). The screw hole 27a is recessed to a lower side from an upper face of the output shaft 27. The fixing bolt 30 is passed through the passing hole 12b from an upper side of the fixed part 12a and is screwed into the screw hole 27a, and a head part of the fixing bolt 30 is disposed on an upper side of the fixed part 12a.

The lifting bolt 31 is a set bolt in which an outside diameter of its head part and an outside diameter of its shaft part are equal to each other. For example, the lifting bolt 31 is a hexagon socket head set screw whose one end face is formed with a hexagonal hole. The lifting bolt 31 is disposed so that an axial direction of the lifting bolt 31 and the upper and lower direction are coincided with each other. The base end part of the third arm part 12 is formed with a screw hole 12c with which the lifting bolt 31 is engaged (specifically, with which a male screw formed in the shaft part of the lifting bolt 31 is engaged). The screw hole 12c is penetrated through the fixed part 12a in the upper and lower direction. The lifting bolt 31 is screwed into the screw hole 12c from an upper side of the fixed part 12a. A length of the lifting bolt 31 is set longer than a thickness of the fixed part 12a (thickness in the upper and lower direction), and a lower end of the lifting bolt 31 is capable of contacting with an upper face of the output shaft 27.

As shown in FIG. 4, twelve fixing bolts 30 are arranged in a circular ring shape with a turning center of the third arm part 12 with respect to the second arm part 11 as a center. Further, the twelve fixing bolts 30 are arranged at an equal angle with the turning center of the third arm part 12 with respect to the second arm part 11 as a center. Four lifting bolts 31 are arranged in a circular ring shape with the turning center of the third arm part 12 with respect to the second arm part 11 as a center. Further, the four lifting bolts 31 are arranged at an equal angle with the turning center of the third arm part 12 with respect to the second arm part 11 as a center. In this embodiment, the lifting bolts 31 are disposed on an outer peripheral side with respect to the fixing bolts 30 arranged in a circular ring shape.

Further, as described above, the speed reducer 17 is also disposed in the joint part 19. In the joint part 19, a case body 26 is fixed to an upper face part on the tip end side of the first arm part 10, and a base end part of the second arm part 11 is fixed to an output shaft 27 from an upper side. The output shaft 27 is turnably held by an upper face part on a tip end side of the first arm part 10 through a bearing 28 and the case body 26. In the joint part 19, the output shaft 27 is a turning member to which the second arm part 11, that is a supported part in a relationship between the first arm part 10 and the second arm part 11, is fixed from an upper side and which is turned together with the second arm part 11, and the output shaft 27 that is the turning member is turnably held by the first arm part 10 that is a support part in a relationship between the first arm part 10 and the second arm part 11.

The joint part 19 is, similarly to the joint part 20, arranged with a plurality of fixing bolts 30 for fixing the second arm part 11 to the output shaft 27 and a plurality of lifting bolts 31 for lifting the second arm part 11 with respect to the output shaft 27. The joint part 19 is, for example, arranged with twelve fixing bolts 30 and four lifting bolts 31. In the joint part 19, similarly to the joint part 20, a base end part of the second arm part 11 is formed with a passing hole through which a shaft part of the fixing bolt 30 is passed, and the output shaft 27 is formed with a screw hole with which the fixing bolt 30 is engaged. The base end part of the second arm part 11 is formed with a screw hole with which the lifting bolt 31 is engaged and a lower end of the lifting bolt 31 is capable of contacting with an upper face of the output shaft 27. The joint part 19 is, similarly to the joint part 20, disposed with the fixing bolts 30 and the lifting bolts 31.

Further, as described above, the speed reducer 17 is also disposed in the joint part 18. In the joint part 18, a case body 26 is fixed to an upper end part of the main body part 7 (specifically, an upper end part of the lifting part 14), and a base end part of the first arm part 10 is fixed to an output shaft 27 from an upper side. The output shaft 27 is turnably held by an upper end part of the lifting part 14 through a bearing 28 and a case body 26. In the joint part 18, the output shaft 27 is a turning member to which the first arm part 10, that is a supported part in a relationship between the main body part 7 and the first arm part 10, is fixed from an upper side and is turned together with the first arm part 10, and the output shaft 27 that is the turning member is turnably held by the main body part 7 that is a support part in a relationship between the main body part 7 and the first arm part 10.

The joint part 18 is, similarly to the joint part 20, arranged with a plurality of fixing bolts 30 for fixing the first arm part 10 to the output shaft 27 and a plurality of lifting bolts 31 for lifting the first arm part 11 with respect to the output shaft 27. The joint part 18 is, for example, arranged with twelve fixing bolts 30 and four lifting bolts 31. In the joint part 18, similarly to the joint part 20, a base end part of the first arm part 10 is formed with a passing hole through which a shaft part of the fixing bolt 30 is passed, and the output shaft 27 is formed with a screw hole with which the fixing bolt 30 is engaged. The base end part of the first arm part 10 is formed with a screw hole with which the lifting bolt 31 is engaged, and a lower end of the lifting bolt 31 is capable of contacting with an upper face of the output shaft 27. The joint part 18 is, similarly to the joint part 20, disposed with the fixing bolts 30 and the lifting bolts 31.

After the robot 1 has been assembled, for example, before the robot 1 is shipped from a factory, in order to adjust inclinations of turning center axes of the hands 4 and 5 with respect to the upper and lower direction when the arm 6 is extended, a shim 33 is sometimes inserted between the base end part of the third arm part 12 and the upper face of the output shaft 27 (specifically, between the lower face of the fixed part 12a and the upper face of the output shaft 27) in the joint part 20. In this case, as shown in FIG. 5, after a worker has loosened the fixing bolts 30, the lifting bolts 31 are screwed so that the lifting bolts 31 are moved to a lower side to lift the third arm part 12 with respect to the output shaft 27, and a shim 33 is inserted between the base end part of the third arm part 12 and the upper face of the output shaft 27. When the shim 33 has been inserted between the base end part of the third arm part 12 and the upper face of the output shaft 27, the worker has loosened the lifting bolts 31 so that the lifting bolts 31 are moved to an upper side and then, the fixing bolts 30 are fastened (see FIG. 3).

Similarly, in order to adjust inclinations of the turning center axes of the hands 4 and 5 with respect to the upper and lower direction, in a case that a shim 33 is to be inserted between a base end part of the second arm part 11 and an upper face of the output shaft 27 in the joint part 19, a worker has loosened the fixing bolts 30 and, after that, the worker screws the lifting bolts 31 so that the second arm part 11 is lifted with respect to the output shaft 27, and a shim 33 is inserted between the base end part of the second arm part 11 and the upper face of the output shaft 27. When the shim 33 has been inserted between the base end part of the second arm part 11 and the upper face of the output shaft 27, the worker has loosened the lifting bolts 31 so that the lifting bolts 31 are moved to an upper side and then, the fixing bolts 30 are fastened.

Similarly, in order to adjust inclinations of the turning center axes of the hands 4 and 5 with respect to the upper and lower direction, in a case that a shim 33 is to be inserted between a base end part of the first arm part 10 and an upper face of the output shaft 27 in the joint part 18, a worker has loosened the fixing bolts 30 and, after that, the worker screws the lifting bolts 31 so that the first arm part 10 is lifted with respect to the output shaft 27, and a shim 33 is inserted between the base end part of the first arm part 10 and the upper face of the output shaft 27. When the shim 33 has been inserted between the base end part of the first arm part 11 and the upper face of the output shaft 27, the worker has loosened the lifting bolts 31 so that the lifting bolts 31 are moved to an upper side and then, the fixing bolts 30 are fastened.

### Principal Effects in this Embodiment

As described above, in this embodiment, the robot 1 includes the lifting bolt 31 for lifting the third arm part 12 with respect to the output shaft 27 in the joint part 20. Therefore, in this embodiment, when the lifting bolts 31 are turned in a state that the fixing bolts 30 have been loosened, the third arm part 12 can be lifted with respect to the output shaft 27 which is turnably held by the second arm part 11. Accordingly, in this embodiment, lifting work for the third arm part 12 with respect to the output shaft 27 can be performed easily. Further, in this embodiment, lifting work for the third arm part 12 with respect to the output shaft 27 can be performed easily and thus, work for inserting a shim 33 between the output shaft 27 and the third arm part 12 can be performed easily.

Similarly, in this embodiment, in the joint part 19, when the lifting bolts 31 are turned in a state that the fixing bolts 30 have been loosened, the second arm part 11 can be lifted with respect to the output shaft 27 and thus, lifting work for the second arm part 11 with respect to the output shaft 27 can be performed easily. Further, lifting work for the second arm part 11 with respect to the output shaft 27 can be performed easily and thus, work for inserting a shim 33 between the output shaft 27 and the second arm part 11 can be performed easily.

Further, in this embodiment, in the joint part 18, when the lifting bolts 31 are turned in a state that the fixing bolts 30 have been loosened, the first arm part 11 can be lifted with respect to the output shaft 27 and thus, lifting work for the first arm part 11 with respect to the output shaft 27 can be performed easily. Further, lifting work for the first arm part 11 with respect to the output shaft 27 can be performed easily and thus, work for inserting a shim 33 between the output shaft 27 and the first arm part 11 can be performed easily.

### Modified Embodiment of Industrial Robot

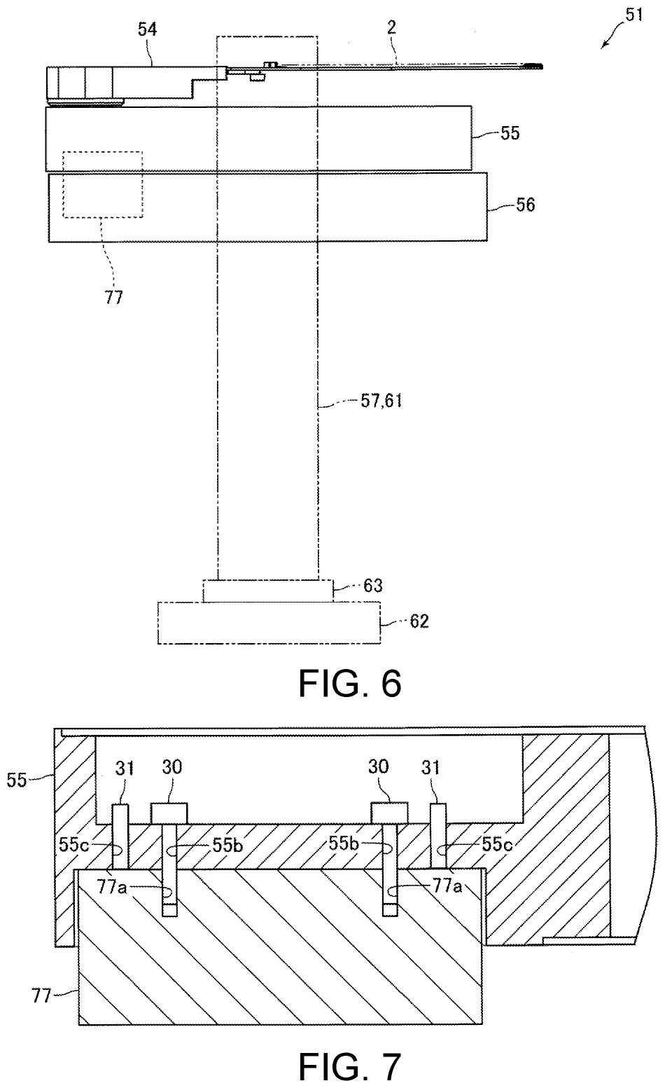

FIG. 6 is a side view showing an industrial robot in accordance with another embodiment of the present invention. FIG. 7 is an explanatory cross-sectional view showing a structure of a connecting part of a slide part 55 with a slide holding part 56 shown in FIG. 6.

In the embodiment described above, the robot 1 is a horizontal multi-joint type robot. However, an industrial robot 51 to which the present invention is applied (hereinafter, referred to as a “robot 51”) may include, for example, as shown in FIG. 6, a hand 54 on which a wafer 2 is mounted, a slide part 55 with which the hand 54 is slidably connected, a slide holding part 56 with which the slide part 55 is slidably connected, and a main body part 57 which holds the slide holding part 56. The hand 54 is capable of linearly sliding in a horizontal direction (right and left direction in FIG. 6) with respect to the slide part 55. The slide part 55 is capable of linearly sliding in the same direction as a moving direction of the hand 54 with respect to the slide holding part 56.

The hand 54, the slide part 55 and the slide holding part 56 are disposed in this order from an upper side in the upper and lower direction. In other words, the slide part 55 is disposed on a lower side with respect to the hand 54, and the slide holding part 56 is disposed on a lower side with respect to the slide part 55. In this modified embodiment, the slide part 55 is a supported part, and the slide holding part 56 is a support part which is disposed on a lower side with respect to the slide part 55, that is the supported part, and with which the slide part 55 is linearly slidably connected.

The hand 54 is, for example, structured similarly to the hand 5 in the embodiment described above. The main body part 57 includes a column-shaped frame 61 which holds the slide holding part 56 so as to be capable of lifting and lowering. The column-shaped frame 61 is formed in a column shape which is long and slender in the upper and lower direction. Further, the main body part 57 includes a base 62 which structures a lower end part of the main body part 57, and a turnable base 63 to which a lower end of the column-shaped frame 61 is fixed and which is turnable with respect to the base 62. The base 62 is horizontally movable with respect to a base member not shown.

The robot 51 includes a first slide mechanism structured to slide the hand 54 with respect to the slide part 55, and a second slide mechanism structured to slide the slide part 55 with respect to the slide holding part 56. The first slide mechanism includes a slider to which the hand 54 is fixed. The slider is slidably held by the slide part 55. Further, the first slide mechanism includes, for example, a ball screw for linearly moving the slider, a motor for rotating a screw shaft of the ball screw and the like.

The second slide mechanism includes a slider 77 to which the slide part 55 is fixed. The slider 77 is slidably held by the slide holding part 56. Further, the second slide mechanism includes, for example, a ball screw for linearly moving the slider 77, a motor for rotating a screw shaft of the ball screw and the like. The slide part 55 is fixed to the slider 77 from an upper side. In this modified embodiment, the slider 77 is a slide member to which the slide part 55 that is a supported part is fixed from an upper side and which is slid together with the slide part 55, and the slider 77 is slidably held by the slide holding part 56 that is a support part.

A connecting portion of the slide part 55 with the slide holding part 56 is arranged with a plurality of fixing bolts 30 for fixing the slide part 55 to the slider 77, and a plurality of lifting bolts 31 for lifting the slide part 55 with respect to the slider 77. The slide part 55 is formed with a passing hole 55b through which a shaft part of the fixing bolt 30 is passed, and the slider 77 is formed with a screw hole 77a with which the fixing bolt 30 is engaged. The slide part 55 is formed with a screw hole 55c with which the lifting bolt 31 is engaged. A lower end of the lifting bolt 31 is capable of contacting with an upper face of the slider 77.

In this modified embodiment, for example, in FIG. 6, in order to adjust an inclination of the hand 54 when the hand 54 has been moved to a right end with respect to the slide part 55 and, in addition, the slide part 55 has been moved to a right end with respect to the slide holding part 56, a shim is sometimes inserted between the slide part 55 and an upper face of the slider 77. In this case, after a worker has loosened the fixing bolts 30, the lifting bolts 31 are screwed so that the lifting bolts 31 are moved to a lower side to lift the slide part 55 with respect to the slider 77, and a shim is inserted between the slide part 55 and the upper face of the slider 77. When the shim 33 has been inserted between the slide part and the upper face of the slider 77, the worker has loosened the lifting bolts 31 so that the lifting bolts 31 are moved to an upper side and then, the fixing bolts 30 are fastened.

In this modified embodiment, the robot 51 includes the lifting bolt 31 for lifting the slide part 55 with respect to the slider 77 and thus, when the lifting bolt 31 is turned in a state that the fixing bolt 30 has been loosened, the slide part 55 can be lifted with respect to the slider 77 which is slidably held by the slide holding part 56. Therefore, lifting work for the slide part 55 with respect to the slider 77 can be performed easily. Further, lifting work for the slide part 55 with respect to the slider 77 can be performed easily and thus, work for inserting a shim between the slider 77 and the slide part 55 can be performed easily.

### Other Embodiments

Although the present invention has been shown and described with reference to a specific embodiment, various changes and modifications will be apparent to those skilled in the art from the teachings herein.

In the embodiment described above, the lifting bolts 31 may be disposed on an inner peripheral side with respect to the fixing bolts 30 arranged in a circular ring shape. Further, in the embodiment described above, the number of the lifting bolts 31 disposed in the joint part 20 may be three, or the number may be five or more. Similarly, the number of the lifting bolts 31 disposed in the joint parts 18 and 19 may be three, or the number may be five or more. Further, in the embodiment described above, the lifting bolt 31 may be a bolt other than a set bolt such as a bolt with a hexagonal hole or a hexagon headed bolt.

In the embodiment described above, it may be structured so that a screw hole with which the lifting bolt 31 is engaged is formed in the output shaft 27, and that an upper end of the lifting bolt 31 is capable of contacting with a lower face of a base end part of the first arm part 10, a lower face of a base end part of the second arm part 11, or a lower face of a base end part of the third arm part 12. However, in the embodiment described above, the lifting bolt 31 is turned from an upper side with respect to the base end part of the first arm part 10, the base end part of the second arm part 11, and the base end part of the third arm part 12 to lift the first arm part 10, the second arm part 11 and the third arm part 12 with respect to the output shaft 27 and thus, in the embodiment described above, lifting work for the first arm part 10, the second arm part 11 and the third arm part 12 can be further easily performed.

In the embodiment described above, instead of the speed reducer 17, the joint part 20 may be arranged with a turning member formed in a cylindrical tube shape and a support shaft which turnably holds the turning member. In this case, for example, the support shaft is fixed to a tip end part of the second arm part 11, and the turning member is turnably held by the second arm part 11 through the support shaft. Further, in this case, for example, a base end part of the third arm part 12 is fixed to the turning member from an upper side, and a pulley 21 is fixed to a lower end part of the turning member. Further, in this case, a fixing bolt 30 for fixing the third arm part 12 to the turning member and a lifting bolt 31 for lifting the third arm part 12 with respect to the turning member are disposed in the joint part 20. Similarly, instead of the speed reducer 17, the joint parts 18 and 19 may be arranged with a turning member formed in a cylindrical tube shape and a support shaft which turnably holds the turning member.

In the embodiment described above, a joint part connecting the hands 4 and 5 with the third arm part 12 may be arranged with a turning member to which the hands 4 and 5 are fixed from an upper side so as to be turned together with the hands 4 and 5 and which is turnably held by the third arm part 12, fixing bolts 30 for fixing the hands 4 and 5 to the turning member, and lifting bolts 31 for lifting the hands 4 and 5 with respect to the turning member. In this case, in a relationship between the hands 4 and 5 and the third arm part 12, the hands 4 and 5 are supported parts and the third arm part 12 is a support part.

In the embodiment described above, it may be structured that no lifting bolt 31 is disposed in one or two of the joint parts 18 through 20. Further, in the embodiment described above, the arm 6 may be structured of two arm parts, or may be structured of four or more arm parts. In addition, in the embodiment described above, only one hand may be attached to a tip end side of the third arm part 12. Further, in the embodiment described above, the robot 1 may be a robot structured to convey a conveyance object such as a glass substrate for a liquid crystal display other than a wafer 2.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An industrial robot, which is a horizontal multi-joint type industrial robot, comprising:
a supported part;
a support part which is disposed on a lower side with respect to the supported part and with which the supported part is turnably connected;
a turning member to which the supported part is fixed from an upper side so as to be turned together with the supported part and which is turnably held by the support part;
a fixing bolt configured for fixing the supported part to the turning member; and
a lifting bolt configured for lifting the supported part with respect to the turning member.

2. The industrial robot according to claim 1, further comprising:
a hand;
an arm with which the hand is turnably connected on a tip end side of the arm; and
a main body part with which a base end side of the arm is turnably connected,
wherein the arm comprises an upper side arm part as the supported part and a lower side arm part as the support part, and
wherein a base end side of the upper side arm part is turnably connected with a tip end side of the lower side arm part.

3. The industrial robot according to claim 2, wherein
the arm comprises:
a first arm part whose base end side is turnably connected with the main body part;
a second arm part whose base end side is turnably connected with a tip end side of the first arm part; and
a third arm part whose base end side is turnably connected with a tip end side of the second arm part,
in a relationship between the first arm part and the second arm part, the first arm part is the lower side arm part and the second arm part is the upper side arm part, and
in a relationship between the second arm part and the third arm part, the second arm part is the lower side arm part and the third arm part is the upper side arm part.

4. The industrial robot according to claim 1, further comprising:
a hand;
an arm with which the hand is turnably connected on a tip end side of the arm; and
a main body part as the support part with which a base end side of the arm is turnably connected,
wherein the arm comprises a first arm part as the supported part whose base end side is turnably connected with the main body part.

5. The industrial robot according to claim 1, wherein
the supported part is provided with a screw hole with which the lifting bolt is engaged, and
a lower end of the lifting bolt is capable of contacting with an upper face of the turning member.

6. The industrial robot according to claim 2, wherein
the supported part is provided with a screw hole with which the lifting bolt is engaged, and
a lower end of the lifting bolt is capable of contacting with an upper face of the turning member.

7. The industrial robot according to claim 3, wherein
the supported part is provided with a screw hole with which the lifting bolt is engaged, and
a lower end of the lifting bolt is capable of contacting with an upper face of the turning member.

8. The industrial robot according to claim 4, wherein
the supported part is provided with a screw hole with which the lifting bolt is engaged, and
a lower end of the lifting bolt is capable of contacting with an upper face of the turning member.

9. An industrial robot, comprising:
a supported part;
a support part which is disposed on a lower side with respect to the supported part and is connected with the supported part so that the supported part is capable of linearly sliding;
a slide member to which the supported part is fixed from an upper side and which is capable of sliding together with the supported part and is slidably held by the support part;
a fixing bolt configured for fixing the supported part to the slide member; and
a lifting bolt configured for lifting the supported part with respect to the slide member.
